(19) United States
(12) Patent Application Publication
(10) Pub. No.: US 2026/0081410 A1
(43) Pub. Date: Mar. 19, 2026

(54) ONE-WAY RETRACTABLE CABLE UNIT WITH MAGNETIC CENTER

(71) Applicant: Joel Dennis, Stanley, ND (US)

(72) Inventor: Joel Dennis, Stanley, ND (US)

(21) Appl. No.: 18/888,838

(22) Filed: Sep. 18, 2024

(51) Int. Cl. H02G 3/32; H02G 11/02

(52) U.S. Cl. CPC H02G 3/32; H02G 11/02

(57) ABSTRACT

A mounting device can include a base device at an initial position. The mounting device can also include a first cable extending away from the base device in a horizontal direction. One end of the first cable can be configured within the base device. A mount can be positioned over a center region of the base device. The mount can include one or more magnetic layers while being positioned over the base device. A second cable can be positioned within the base device at an opposite end from the first cable.

### TECHNICAL FIELD

Embodiments of the invention relate to a magnetic mounting apparatus with a retractable cable that enables the apparatus to fit on any standard table and be utilized for data transfer and charging.

### BACKGROUND

Current products involve two-way retractable cables. Many of these products with the two-way retractable cables are designed for travel and not for homes. Such systems often cannot be plugged into a wall or a computer since both ends of the two-way cable system retract. The charging capabilities of these two-way cable systems can be slow as well.

Such two-way cable retracting systems also may not be used effectively for data transfer. The position of where to place such systems can be limited, and the charging capability and quality of the cables may be limited as well. As such, the data transfer capabilities can be limited and more cumbersome and require more effort due to these limitations. Such systems typically cannot be used at home, or connected to a wall or computer. Its charging capabilities and data transfer can be somewhat limited due to the need of having two extended cables.

A need exists to have an extending cable system that allows for faster charging capabilities and better data transfer abilities. Further, a need exists to place the extending cable system against a wall or connect it to a computer. A need also exists for a system that uses only one cable as opposed to two cables, and thereby provide more space on the table or desk for the user. Users also need to be able to use such a system at home. A system that provides more space for the user, and also improves data transfer and charging capabilities, and which can be used at home is currently needed at this time.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to an apparatus and system for a magnetic mounting apparatus. A base device can be configured at an initial position on a desk or a table. A first cable can extend away from the base device in a horizontal direction. Another end of the first cable can be initiated within the base device. A mount can be positioned in a center region of the base device. The mount can include one or more magnetic layers as well. A second cable can be positioned within the base device at an opposite end from the first cable.

The second cable can be configured in a retracted position within the base device.

A clamping mechanism can be attached to an exterior portion of the base device.

In one aspect, the mount is configured in a circular shape over the base device.

In one aspect, a clamping connector can extend in a perpendicular direction to the base device.

In one aspect, the second cable is configured around a circumference of the base device.

In one aspect, the base device is configured in a circular shape underneath the mount configured over the base device.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a top view of magnetic mounting apparatuses according to some embodiments;

FIG. 2 illustrates a front view of a magnetic mounting apparatus connected to a USB power source according to some embodiments;

FIG. 3 illustrates a front view of magnetic mounting apparatuses stacked on to each other according to some embodiments; and

FIG. 4 illustrates a magnetic mounting apparatus being placed on an adhesive mounting pad according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a magnetic mounting apparatus that can be placed anywhere on a table or desk for a user. The magnetic mounting apparatus can include a circular base device. On top of the base device is a magnetic mount configured in a circular shape. The magnetic mount can have magnetic layers at the top of the magnetic mount, and which extend downward toward the base device. The magnetic mount and base device can collectively secure the magnetic mounting apparatus onto a clamping device or adhesive mounting pad on a table/desk. The base device and magnetic mount collectively can be rotated at various positions on the table or desk. The magnetic mounting apparatus can include an extending cable that can extend from the magnetic mounting apparatus to a wall or ground outlet. The magnetic mounting apparatus can also include a retractable cable that is positioned within the magnetic mounting apparatus, and extended outward when connected to a power source. Data transfer and charging can occur using the retractable cable with the magnetic mounting apparatus.

The retractable cable can be placed around a circumference of the base device. The retractable cable can stay positioned within the circumference of the base device when it is not connected to a USB device. As a result, extra space is provided for the user as the entire magnetic mounting apparatus does not take up excessive space on the table or desk when the retractable cable is not in use.

A clamp can be used to secure the magnetic mounting apparatus at an edge of the table or desk. However, in other embodiments, the user can move the magnetic mounting apparatus to other portions of the table or desk. In such embodiments, an adhesive mounting pad with a sticky center region can be used to be attached to a bottom portion of the magnetic mounting apparatus to secure the magnetic mounting apparatus in place on the table or desk. As such, the magnetic mounting apparatus provides increased charging and data transfer capabilities without taking up a large amount of space. Further, using either the clamp or adhesive mounting pad, the magnetic mounting apparatus can be used in a variety of positions on the table or desk.

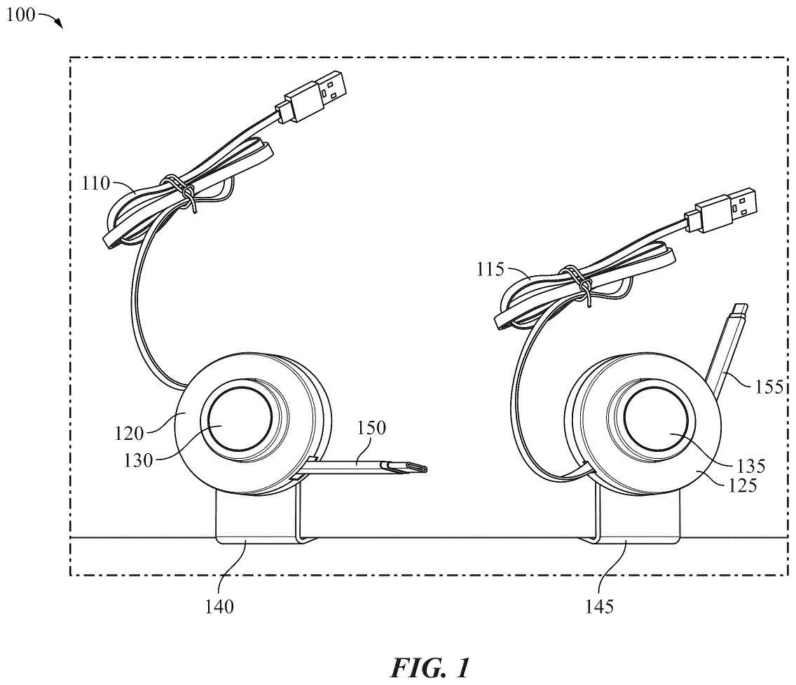

FIG. 1 illustrates a top view of a dual magnetic mounting system (system) 100. Two base devices 120, 125 can be positioned on a table. The base devices 120, 125 can each have a circular or round shape in some embodiments. Circular mounts 130, 135 can be positioned in a center region in each of the base devices 120, 125. The circular mounts 130, 135 can also each have a circular shape within the center region of their respective base devices 120, 125. The base devices 120, 125 and circular mounts 130, 135 collectively can be rotated on the table or desk in various intervals. Rotating capabilities of the system 100 are present with the base devices 120, 125 and circular mounts 130, 135. The circular mounts 130, 135 can each have magnetic layers that can start at top portion of each of the circular mounts 130, 135, and extend downward to the base devices 120, 125. The circular mounts 130, 135 and the base devices 120, 125 can provide support for the magnetic mounting apparatus to remain securely in place on a table or desk.

Referring to FIG. 1, an extending cable 110, 115 can extend from both of the base devices 120, 125. The extending cable 110, 115 can be connected to a USB outlet on a wall or computer. The extending cable 110, 115 can extend in a horizontal direction away from each base device 120, 125 and be connected to the USB wall or computer outlet. Each extending cable 110, 115 can provide for improved data transfer and charging for the system 100 due to an increased charging speed and quality of each extending cable 110, 115. Each base device 120, 125 also include a retractable cable 150, 155. The retractable cable 150, 155 in each base device 120, 125 is configured around a circumference of the respective base device 120, 125. The retractable cable 150, 155 does not extend on the table when not in use.

In FIG. 1, when the retractable cable 150, 155 is in use, the retractable cable 150, 155 can be plugged into a mobile phone or other display device. The retractable cable 150, 155 is only extended from the base device 120, 125 when in use. As such, space around both base devices 120, 125 within the system 100 is saved due to the retractable cable 150, 155 within each base device 120, 125 stored around their respective base devices 120, 125 when not in use.

In FIG. 1, in order to be attached to a table, each base device 120, 125 can include a clamp 140, 145. The clamp 140, 145 for each base device 120, 125 can extend around an edge of the table or desk. A portion of each clamp 140, 145 can extend from the respective base device 120, 125 to the edge of the table. Another portion of each clamp 140, 145 can be perpendicular to the first portion of each clamp 140, 145, and extend downward in the vertical direction. As such, each clamp 140, 145 can include a horizontal first portion that extends from each base device 120, 125 to the edge of the table. Each clamp 140, 145 can also thereby include a second vertical portion that extends from the edge of the table downward in the vertical direction. Both portions of each clamp 140, 145 secure each base device 120, 125, mount 130, 135, extending cable 110, 115, and retractable cable 150, 155 of the system 100 onto the corresponding table or desk.

Overall, in FIG. 1, the system 100 includes two mounts 130, 135 that provide magnetic layers over the base devices 120, 125. The mounts 130, 135 and the base devices 120, 125 can be rotated in various embodiments. In other embodiments, the mounts 130, 135 can also be stacked on to each other as well. Further, the retractable cable 150, 155 is the only cable from each base device 120, 125 that extends toward a USB device such as a phone or other display devices. As such, space is saved on the table for a user to perform other work on the table. The capabilities of each retractable cable 150, 155 improve data transfer and charging capabilities of the system 100 as well. The retracted cable 150, 155 stays within the respective base device 120, 125 without taking additional space when not in use. The clamp 140, 145 ensures that the base devices 120, 125, mounts 130, 135, extending cables 110, 115, and retractable cables 150, 155 remain positioned securely onto the table or desk.

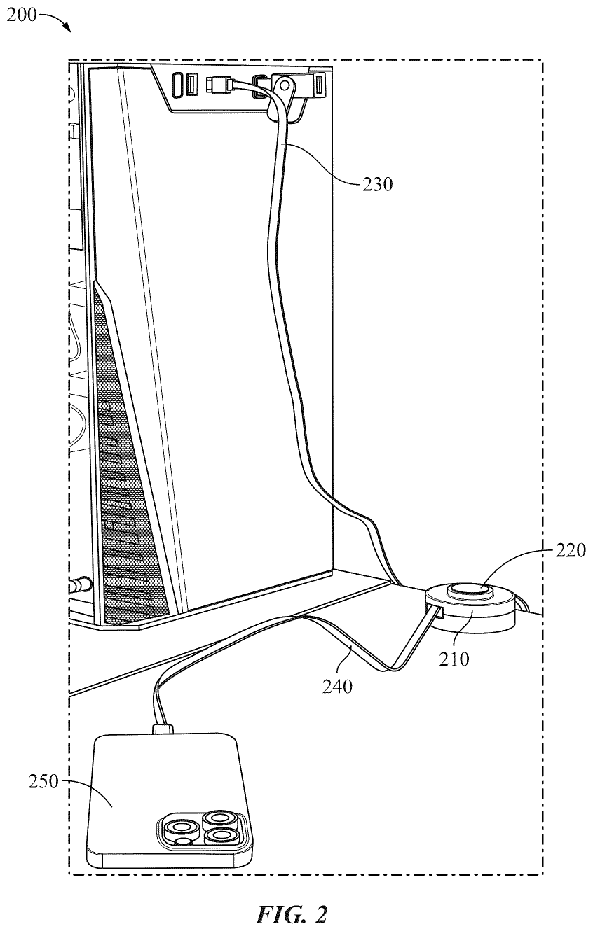

Referring to FIG. 2, a system 200 is illustrated in which a magnetic mounting apparatus is positioned on a desk and connected to a power source such as a USB wall adapter or computer. A user can use the magnetic mounting apparatus with many USB devices for charging and work-related purposes without taking up a lot of space on the table or desk.

In FIG. 2, the system 200 includes a magnetic mounting apparatus with a base device 210. The base device 210 can be configured around the edge of the table in some embodiments. The base device 210 can be configured to have a circular or round shape as it is positioned on the desk or table. A mount 220 can be positioned in a center region of the base device 210. The mount 220 and base device 210 can help secure the magnetic mounting device in place on the table. The mount 220, as what was described in FIG. 1, can be configured in a round or circular shape in a center of the base device 210, and on top of the base device 210. The mount 220 can include magnetic layers that extend from a top portion of the mount 220 and extend vertically downward toward the base device 210. The mount 220 and base device 210 can have rotation capabilities and can be rotated in various positions on the table or desk.

Referring again to FIG. 2, the base device 210 can include an extending cable 230 that is placed within a wall outlet. The extending cable 230 will extend away from the base device 210 and the mount 220. A retractable cable 240 can also be positioned within the base device 210. When not in use, the retractable cable 240 can be positioned around the circumference of the base device 210 as shown in FIG. 1. However, in other embodiments, the user may want to use the retractable cable 240 onto a power source such as a mobile phone 250 shown in FIG. 2. As such, the user can extend the retractable cable 240 from the base device 210 and connect the retractable cable 240 to the mobile phone 250. In other embodiments, other devices other than the mobile phone 250 can be used. When the user has completed use of the retractable cable 240, the retractable cable 240 can then be repositioned again within the base device 210 to save additional space on the table. No other portion of the magnetic mounting apparatus takes up any space on the table after the retractable cable 240 is placed back within the base device 210. The improved quality of the retractable cable 240 as opposed to cables of other systems can also improve the charging and data transfer capabilities of the magnet mounting apparatus as it is used in conjunction with the power source or mobile phone 250. The magnetic mounting apparatus can also be secured at the edge of the table or desk by the clamp. A horizontal portion of the clamp can extend from the base device 210 to the edge of the table or desk. A vertical portion of the clamp can wrap around the edge of the desk and extend vertically downward away from the base device 210.

In FIG. 2, in summary, a lot of space can be saved by a user working on the power source such as the mobile phone 250. The retractable cable 240 can safely extend from the mount 220 and base device 210 toward the mobile phone 250 or other USB device. No other portion of the magnetic mounting apparatus needs to be applied to connect to the mobile phone 250 as the extending cable 230 extends away from the base device 210 and mount 220 toward the wall outlet. The retractable cable 240 will stay within a circumference of the base device 210 without taking up space when it is not in use. The user will have ample area on the table or desk to perform the desired tasks on the mobile phone 250. The retractable cable 240 can also improve the data transfer and charging capabilities of the magnetic mounting apparatus as it is connected to the mobile phone 250 as well.

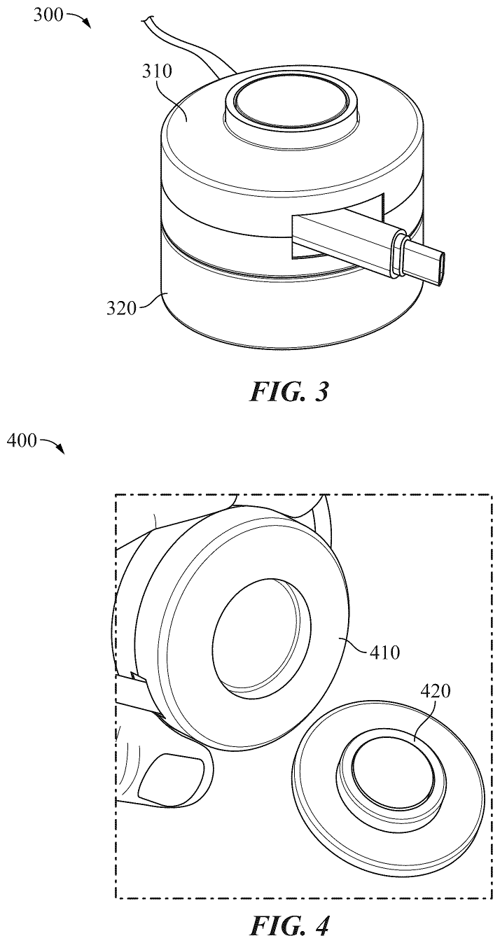

Referring to FIG. 3, a system 300 is illustrated in which multiple magnetic mounting apparatuses are positioned on together, with one of the apparatus stacked on top of the other apparatus. In some embodiments, multiple magnetic mounting apparatuses can be stacked on to each other to give the user options to use multiple devices to be attached to the magnetic mounting apparatuses without taking excess space on the desk or table.

In FIG. 3, the system 300 with a first magnetic mounting apparatus 310 configured over a second magnetic mounting apparatus 320 is illustrated. Both the first and second magnetic mounting apparatus 310, 320 can have an extending cable that extends to a wall or ground outlet. The user can stack both the first and second magnetic mounting apparatuses 310, 320 to save space on the table or desk and charge multiple USB devices such as a phone and tablet at once, or connect two hard drives to a computer at once. Both magnetic mounting apparatuses 310, 320 will include circular and magnetic mounts at a center that have magnetic layers that extend from the top of the mount and vertically downward and also underneath the mounts as well. The base devices and magnetic mounts can help secure the magnetic mounting apparatuses onto a clamping mechanism or adhesive mounting pad. As such, due to the magnetic and circular mounts with the magnetic layers on each portion of the mounts, the magnetic mounting apparatuses 310, 320 can be stacked onto each other and also be rotated by the user. In other embodiments, more than two magnetic mounting apparatuses can be stacked onto each other. The circular mounts with the magnetic layers enable the user to perform the stacking technique to use multiple devices that can be connected to retractable cables within both magnetic mounting apparatuses 310, 320.

With respect to FIG. 3, the system that uses the stacking technique can allow the user greater options to use more devices for work or pleasure in connection with the magnetic mounting apparatuses 310, 320. The space of the user is also not compromised as stacking the magnetic mounting apparatuses does not take up any additional space around the table or desk that is being used. The retractable cable from both magnetic mounting apparatuses 310, 320 can also improve data transfer and charging capabilities of the magnetic mounting apparatuses 310, 320 as well.

Referring to FIG. 4, a system 400 in which a magnetic mounting apparatus can be placed on an adhesive mounting pad without the use of a clamp to secure the magnetic mounting apparatus onto a desk or table. The versatility of the magnetic mounting apparatus also allows the magnetic mounting apparatus to be secured at various positions on the desk or table without requiring a clamp at an edge of the desk or table.

In FIG. 4, the system 400 illustrates a magnetic mounting apparatus 410 and an adhesive mounting pad (pad) 420. A bottom portion of the magnetic mounting apparatus 410 can include a circular opening that is directly underneath a circular and magnetic mount that is positioned at the top of the magnetic mounting apparatus 410. Further, the bottom portion of the magnetic mounting apparatus 410 can include a recessed area that enables the magnetic mounting apparatus 410 to fit securely over the pad 420. The pad 420 can include an adhesive on the bottom of the pad 420 that secures the pad 420 to the desk. When the user wants move the position of the magnetic mounting apparatus 410 from the edge of the desk or table to the middle or other portions, the pad 420 can be used instead of the clamp illustrated in FIGS. 1-2.

With respect to FIG. 4, the pad 420 can provide the user with options to use the magnetic mounting apparatus 410 away from the edge of the desk or table. A center of the pad 420 will allow the magnetic mounting apparatus 410 to be secured onto the pad 420. Accordingly, the user can continue to perform work using the magnetic mounting apparatus 410 when it is secured onto the pad 420.

Overall, the use of the magnetic mounting apparatus provides several advantages for users. The retractable cable within the base device of the apparatus assures that the apparatus does not utilize two cables to take up space on the table or desk when the retractable cable is not in use. The extended cable also extends away from the magnetic mounting apparatus and can remain connected to a USB wall outlet or computer. The magnetic mounting apparatus can be used in a home environment and not simply for travel. The magnetic mount and base device can help secure the magnetic mounting apparatus onto the clamp or the adhesive mounting pad. The improved quality of the retractable cable can also improve the data transfer and charging capabilities of the magnetic mounting apparatus. Another advantage is that either a clamp or an adhesive mounting pad can be used to secure the magnetic mounting apparatus on to the table or desk. If the user prefers to place the magnetic mounting apparatus at an edge of the table or desk, the user can use the clamp to secure the magnetic mounting apparatus at the edge of the table. In other embodiments, if the user desires to use the magnetic mounting apparatus on other areas of the table, the adhesive mounting pad with a sticky region on the bottom of the pad can be used to secure the magnetic mounting apparatus onto the table.

Other advantages can include the stacking technique. A user can stack multiple units of the magnet mounting apparatus onto each other and use them to work with multiple devices. The magnetic mounts at the top and center region of the magnetic mounting apparatuses will allow multiple units to be stacked onto each other. The magnetic mounts and base devices can allow the magnetic mounting apparatuses to be secured onto a clamp or adhesive mounting pad. The stacking technique can allow the user to save space on the table and use multiple USB devices or tablets for work or recreation due to the retractable cables from the magnetic mounting apparatuses. The magnetic mounts and base devices can collectively be rotated as well. This design provides stability so that when the cable is pulled, the device will not move from the mounted position.

As such, the magnetic mounting apparatus enables the user to save space on the table or desk while performing tasks. The user can also use the magnetic mounting apparatus at various positions on the table or desk. In addition, the user can use multiple units of the magnetic mounting apparatus to work with multiple devices to complete desired tasks as well.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described herein above. A variety of modifications and variations are possible in light of the above teachings without departing from the following claims.

What is claimed is:

1. A mounting apparatus comprising:
a base device at an initial position;
a first cable extending from the base device, with one end configured within the base device to another end extending away from the base device;
a mount configured over the base device, wherein the mount is configured with multiple magnetic layers over the base device, and wherein the mount is configured within a center region of the base device; and
a second cable positioned at an opposing end of the base device in relation to the first cable.

2. The mounting apparatus of claim 1, wherein the second cable is configured in a retracted position within the base device.

3. The mounting apparatus of claim 1, further comprising:
a clamping mechanism attached to an exterior portion of the base device.

4. The mounting apparatus of claim 1, wherein the mount is configured in a circular shape over the base device.

5. The mounting apparatus of claim 1, further comprising:
a clamping connector that extends in a perpendicular direction to the base device.

6. The mounting apparatus of claim 1, wherein the second cable is configured around a circumference of the base device.

7. The mounting apparatus of claim 1, wherein the base device is configured in a circular shape underneath the mount configured over the base device.

8. A magnetic mounting apparatus comprising:
a first cable extending in a horizontal direction;
a base device connected to the first cable, wherein the first cable is initiated within the base device;
a circular mount positioned over the base device, wherein the circular mount is positioned within a center of the base device, and configured to extend over the center of the base device; and
a clamping mechanism connected to the base device and circular mount and configured to extend in a perpendicular direction to the base device and circular mount.

9. The magnetic mounting apparatus of claim 8, further comprising:
a second cable configured in a retracted position within the base device.

10. The magnetic mounting apparatus of claim 8, wherein the circular mount is configured with one or more magnetic layers.

11. The magnetic mounting apparatus of claim 8, wherein the base device extends in a circular direction around the circular mount.

12. The magnetic mounting apparatus of claim 8, further comprising:
a second cable extending around the base device and circular mount.

13. The magnetic mounting apparatus of claim 8, further comprising:
one or more magnetic layers extending over the base device.

14. The magnetic mounting apparatus of claim 8, wherein a vertical region of the circular mount is configured between the base device and a top portion of the circular mount.

15. A system comprising:
a first cable connector extending in a horizontal direction;
a base device connected to the first cable connector;
a mounting device configured over the base device, wherein a vertical region of the mounting device is positioned between the base device and a top portion of the mounting device, and wherein a top and bottom portion of the mounting device comprises one or more magnetic layers; and
a clamping mechanism connected to the first cable connector, base device, and mounting device.

16. The system of claim 15, further comprising:
a second cable connector configured around a circumference of the base device.

17. The system of claim 15, wherein one end of the clamping mechanism extends in a perpendicular direction away from the base device.

18. The system of claim 15, wherein the top portion of the mounting device is positioned in a center region over the base device.

19. The system of claim 15, wherein the one or more magnetic layers on the top portion of the mounting device are configured to extend in a circular direction over the base device.

20. The system of claim 15, wherein the first cable connector is configured to extend in a the horizontal direction away from the base device and mounting device.
